(19) United States
(12) Patent Application Publication
(10) Pub. No.: US 2010/0189439 A1
(43) Pub. Date: Jul. 29, 2010

(54) OPTICAL FIBER DISTRIBUTED WIRELESS PERSONAL AREA NETWORK

(76) Inventors: Dalma Novak, Glen Burnie, MD (US); Rodney Waterhouse, Glen Burnie, MD (US)

Correspondence Address: ITALIA IP, 3500 WEST OLIVE AVE., SUITE 300, BURBANK, CA, 91505, US

(21) Appl. No.: 12/358,848

(22) Filed: Jan. 23, 2009

(51) Int. Cl. H04J 14/00

(52) U.S. Cl. 398/67

(57) ABSTRACT

A Wireless Personal Area Network that provides multiple users with multi-gigabit-per-second data rate wireless connectivity and is integrated with an optical fiber distribution network is disclosed. Embodiments relate generally to an integrated fiber optic WPAN architecture that comprises multiple 57-66 GHz remotely located wireless access points interconnected with a centrally located distribution point using optical fiber links. The integrated network provides an efficient, flexible and scalable 57-66 GHz WPAN architecture since the fiber optic links accommodate the delivery of bandwidth intensive services to large numbers of users while seamlessly supporting the diversity of multi-gigabit-per-second data applications. Two approaches for the transport of the WPAN signals over the optical fiber signal distribution network are described. One technique for interconnecting the remote radio access points in the fiber distributed 57-66 GHz WPAN is via an optical fiber network which can transport the wireless signals over the fiber as ‘analog over fiber’. An alternative ‘digital over fiber’ signal transport scheme for the fiber distributed 57-66 GHz WPAN is also described which supports the transport of the multi-gigabit-per-second WPAN digital data streams over fiber.

### FIELD OF THE INVENTION

The subject matter of this application relates generally to wireless communication systems, and in particular relates to a 57-66 Gigahertz (GHz) wireless personal area network (WPAN) integrated with an optical fiber distribution system.

### BACKGROUND OF THE INVENTION

The 57-66 GHz frequency region for WPAN communications is attracting much interest worldwide because of the huge bandwidth that it can provide. A wireless network infrastructure operating in this frequency band would support dense, short range communications since the attenuation (10-15 decibels/kilometer) due to atmospheric oxygen at this frequency makes the band unsuitable for longer range communications. With the recent worldwide allocation of general unlicensed spectrum in the 57-66 GHz frequency band for short range WPAN communications, including: 57-64 GHz in USA, Canada and Korea, 59-66 GHz in Japan, 57-66 GHz in Europe, as well as 59.4-62.9 GHz in Australia, there is now an opportunity to exploit this resource for the wireless communication of new bandwidth intensive (multi-gigabit-per-second data rates) applications and services. These applications include multiple user high data rate networking, home or office real time video streaming downloads, wireless data bus for cable replacement, and multimedia distribution in environments such as buildings, exhibition halls, aircraft and trains.

The basic entity of a 57-66 GHz Wireless Personal Area Network will be a short range radio cell, comprising a wireless or radio access point and multiple users or terminals located within the coverage area of the cell. A radio cell is a single area, up to 10 meters in diameter, within which it will be possible to establish reliable two-way or bi-directional wireless communications at a carrier frequency of 57-66 GHz between the wireless access point and the users' fixed or mobile terminals. The properties of 57-66 GHz radio waves combined with the inherent limited coverage range of wireless links at this frequency, are such that multiple radio access points located indoors within a single building, hall, or private residence, or outdoors in a public plaza, will be required in order to obtain complete high data rate wireless coverage. To link the various radio access points together, some kind of backbone network must then be deployed.

### SUMMARY OF THE INVENTION

To fully enable the use of bandwidth-demanding services for a number of users or terminals communicating over shorter distances, a 57-66 GHz WPAN architecture that can support multi-gigabit-per-second data rates as well as multiple radio coverage areas is needed. It is a feature of an embodiment of the present invention to provide an efficient, flexible and scalable mechanism to establish these high bandwidth interconnections between the multiple radio access points in a 57-66 GHz WPAN.

For the interconnection of the multiple WPAN coverage areas, optical fiber cable offers a number of significant advantages over conventional electrical cable signal transport schemes such as coaxial cable and waveguide. These benefits include low signal attenuation loss and path delays, light weight, low cable cost, broad transmission bandwidth capabilities, and immunity to electromagnetic interference. One aspect of the present invention is the integration of a 57-66 GHz WPAN with an optical fiber signal distribution scheme which will provide an efficient means to deliver or transport the WPAN high data rate signals to a large number of radio distribution access points that will ensure optimized radio coverage. This integrated infrastructure will enable an extremely flexible and scalable 57-66 GHz wireless network since the fiber optic links will accommodate the delivery of bandwidth intensive services to large numbers of users while seamlessly supporting the diversity of multi-gigabit-per-second data rate applications.

Another aspect of the invention lies in the implementation of a cost-effective fiber optic distributed WPAN architecture in which a large number of radio access points interconnected with the optical fiber distribution network, can share the WPAN transmission and processing equipment located remotely from the customer serving area at a central distribution point. In this way the WPAN wireless access points can be made functionally simple and compact.

In separate embodiments of the present invention, two approaches for the transport of the WPAN signals over the optical fiber signal distribution network are described. The first technique for interconnecting the remote radio access points in the fiber distributed WPAN system is via an optical fiber network that transports the analog wireless signals over fiber (analog over fiber’). The analog over fiber signal transport scheme reduces the required hardware in the WPAN wireless access point and also simplifies the management of the 57-66 GHz wireless network.

In another embodiment of the present invention, an alternative signal transport scheme for the optical fiber distributed 57-66 GHz WPAN is the transport of the multi-gigabit-per-second WPAN digital data streams over fiber (‘digital over fiber’). In this scenario, the high data rate WPAN signals are up-converted in frequency to the required 57-66 GHz radio frequency band at the remote wireless access point. Bi-directional data transmission in the fiber distributed 57-66 GHz WPAN is accomplished via frequency down-conversion at the wireless access point, whereby the 57-66 GHz wireless carrier received from a user located within the cell coverage area is down converted to a digital signal before transmission back to the central distribution point. Recent advances in analog-to-digital converter (ADC) and digital-to-analog converter (DAC) technology make it possible to locate the ADC and DAC functions closer to the wireless access point, thereby enabling more of the radio functions to be performed in the digital domain. Similar to the analog over fiber signal transport scheme in the fiber distributed 57-66 GHz WPAN, the digital over fiber distribution network will reduce the hardware components required at the radio access point with the processing carried out at the centrally located distribution point.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims. For example, although the figures show an example of a 60 GHz WPAN, it should be appreciated that any frequency in the 57-66 GHz WPAN range would be effective.

### BRIEF DESCRIPTION OF THE DRAWINGS

FIG. 1 is a schematic diagram of a generalized embodiment of an optical fiber distributed 60 GHz Wireless Personal Area Network that provides fixed or mobile user terminals with multi-gigabit wireless data connectivity and supports the interconnection of multiple 60 GHz wireless access points for optimized wireless coverage within a defined indoor or outdoor geographical environment.

FIG. 2 is a block diagram of a generalized embodiment of the central distribution point in the system of FIG. 1 showing the key sub-systems: network interface, RF and digital interface, and optical interface.

FIG. 3 is a block diagram of a generalized embodiment of the wireless access point in the system of FIG. 1 showing the key sub-systems: optical interface, RF interface, and antenna.

### DESCRIPTION OF THE EMBODIMENTS

In the following description, reference is made to the accompanying drawings that form a part thereof, and in which are shown, by way of illustration, specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, not to be taken in a limiting sense.

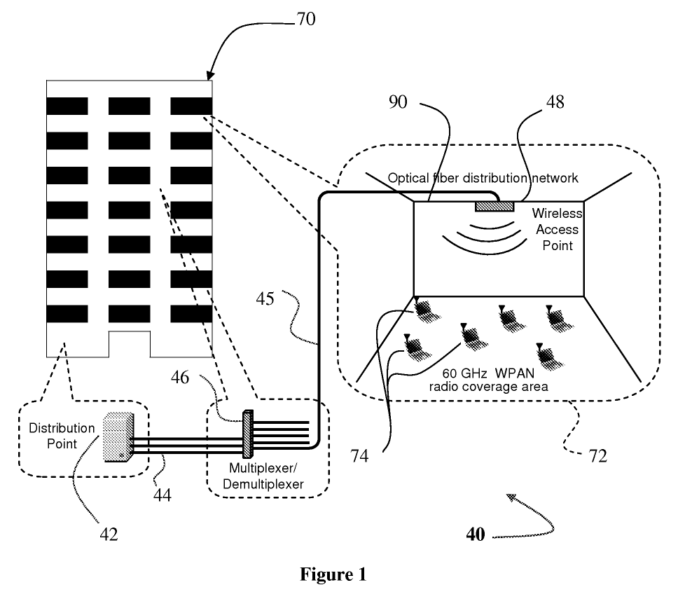

FIG. 1 depicts a schematic diagram 40 of a fiber distributed 57-66 GHz Wireless Personal Area Network (WPAN), and more specifically, a 60 GHz WPAN infrastructure that illustrates an example of the invention. Shown in FIG. 1 is a fiber distributed WPAN that could support a number of multi-gigabit-per-second data applications and interconnected wireless access points, installed within a building 70. As shown in the diagram, the fiber distributed WPAN enables the rapid transfer of large amounts of information (content vending or downloads) for mobile user terminals 74 located in an ad-hoc manner within the building. In the integrated optical fiber 60 GHz WPAN communications network shown in FIG. 1, optical signals carrying the multi-gigabit-per-second WPAN data in either analog or digital signal format, are distributed over optical fiber 44 from a (preferably centrally located) distribution point 42 (connected to an external communications network or IP backbone network) to remotely located 60 GHz radio access points, e.g. 48. The large free-space attenuation loss of the radio signals 90 at 60 GHz will confine the WPAN radio coverage to smaller areas, such as the room environment 72 illustrated in FIG. 1. This provides a number of benefits including and the potential for establishing secure wireless links as well as enhanced system capacity through increased frequency re-use as co-channel interference is significantly reduced.

The radio access point 48 terminal in FIG. 1 provides wireless coverage over a small area (less than 5-10 meters in range), with several access points identical or similar to the radio access point 48, then connected together directly or via a bi-directional multiplexer/demultiplexer 46 via optical fiber 44 and/or 45 to provide radio coverage over a number of spot areas. The wireless connectivity applications depicted in FIG. 1 can range from low megabit/second data rates to multi-gigabit data rates. Applications that could be supported by the optical fiber distributed 60 GHz WPAN system include the transmission of streaming high definition television (HDTV) images, ad-hoc connections between personal computers, streaming audio, and content distribution (video, multimedia, etc). Also envisioned is the extension of the Ethernet Passive Optical Network (EPON) to the 60 GHz WPAN wireless band. High data rate applications that require secure links such as emergency services and homeland security, could also exploit the limited range of radio transmission at 60 GHz.

The use of optical fiber links 44 and/or 45 for distributing the WPAN signals to the remote radio access points provides an efficient mechanism to establish the high bandwidth interconnections between them. As shown in FIG. 1 the fiber distribution network 40 provides a flexible approach for remotely interfacing with multiple access radio points and enables system complexity to be reduced through the use of a centralized architecture that incorporates a simplified wireless access point. In the example shown in FIG. 1, the central distribution point would provide the radio signal switching and processing functionality in the 60 GHz WPAN.

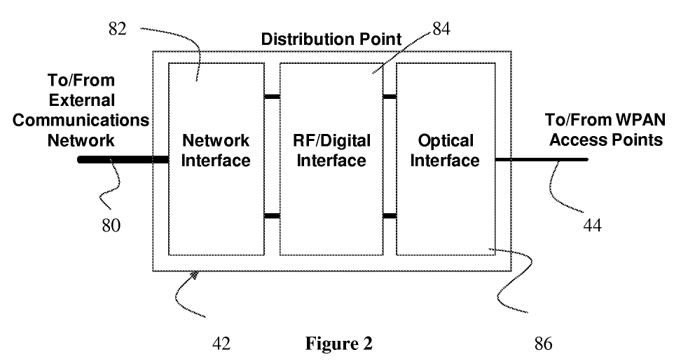

FIG. 2 shows a block diagram showing the key sub-systems of the centrally located distribution point 42 in the optical fiber distributed 60 GHz WPAN. As shown in the block diagram, the distribution point 42 unit incorporates three main parts: a network interface 82, an RF and digital interface 84, and an optical interface 86. The network interface hardware in the distribution point supports the interconnection 80 of the fiber distributed 60 GHz WPAN 40 with an external wired or wireless telecommunications network. The RF and digital interface prepares the multi-gigabit-per-second WPAN data for distribution to the WPAN wireless access points via either analog or digital over fiber (e.g. 44) signal transport. Since the 60 GHz WPAN provides bi-directional multi-gigabit data wireless connectivity, communication from the user terminal (74) back to the distribution point (upstream signal transmission) is also supported by the RF and digital interface 84. Finally, the optical interface 86 in the 60 GHz WPAN distribution point supports the conversion of the electrical analog or digital WPAN signals into optical signals for distribution over fiber 44 to the wireless access points directly or via a multiplexer/demultiplexer 46. As with the RF and digital interface, the optical interface 86 also supports upstream signal transmission; converting the analog or digital optical signals returning from the WPAN wireless access points back into the electrical domain, for passing to the RF and digital interface.

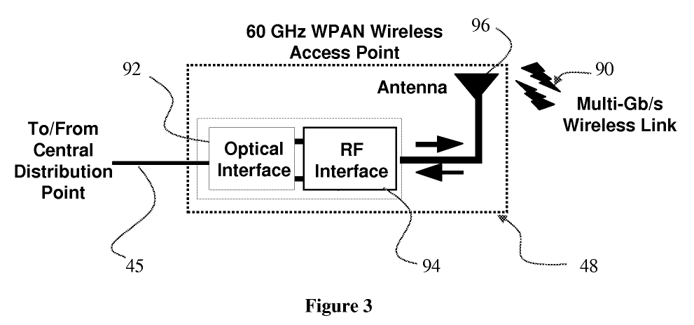

FIG. 3 shows a block diagram showing the key sub-systems of an exemplary wireless access point 48 in the fiber distributed 60 GHz WPAN 40. As shown in the block diagram, the wireless access point unit incorporates three main parts: an optical interface, an RF interface, and an antenna. The optical interface 92 in the 60 GHz WPAN wireless access point supports the conversion of the optical analog or digital WPAN signals received from the distribution point via optical fiber 45 (or directly via optical fiber 44) into electrical signals. In the upstream direction the optical interface 92 also supports the conversion of the electrical analog or digital WPAN signals into optical signals for transport back to the central distribution point 42. The RF interface supports conditioning of the downstream and upstream electrical WPAN signals; providing electronic amplification and also frequency conversion in the fiber distributed WPAN architecture that incorporates digital over fiber signal transport. The antenna 96 in the 60 GHz WPAN access point 48 acts as the radiating element in the wireless link; transmitting and receiving the 60 GHz radio signals 90 to/from user terminals positioned within the radio cell area (72) and enabling multi-gigabit-per-second wireless connectivity.

1. A distributed network, comprising
a distribution point unit including
a network interface connected to an external communications network,
an optical interface connected to an optical fiber,
an RF/Digital interface comprising at least one of an RF and a digital signal interface to provide a signal path between said network interface and said optical interface; and
a wireless access point unit including
an optical interface connected to said optical fiber,
an RF interface connected to provide signals between said optical interface and a corresponding antenna, wherein said signals provided to and from said antenna are substantially within a frequency range of 57-66 GHz providing wireless data connectivity to a distributed network user.

2. The distributed network of claim 1, wherein said optical fiber comprises an element of an optical fiber distribution network.

3. The distributed network of claim 1, wherein at least one user is provided with bi-directional multi-gigabit-per-second data rate wireless data connectivity.

4. The distributed network of claim 1 further including multiple wireless access points interconnected with optical fiber disposed to provide optimized radio coverage area in at least one of indoor and outdoor geographical environments.

5. The distributed network of claim 1, wherein said distribution point unit is substantially centrally located within the network and said wireless access point unit comprises multiple remotely located wireless access point units.

6. The distributed network of claim 1, wherein said signals provided between said wireless access point RF Interface and said wireless access point antenna are 57-66 GHz.

7. The distributed network of claim 1, wherein said optical interface of said distribution point unit and said wireless access point unit provide downstream and upstream optical signals as an analog signal over optical fiber.

8. The distributed network of claim 7, wherein the RF interface of the said wireless access point unit may convert the downstream and upstream analog optical signals to and from signals within the 57-66 GHz frequency range.

9. The distributed network of claim 1, wherein said optical interface of said distribution point unit and said optical interface of said wireless access point unit provide downstream and upstream optical signals each as a digital signal over optical fiber.

10. The distributed network of claim 9, wherein the RF interface of said wireless access point unit converts the downstream and upstream digital optical signals to and from signals within the 57-66 GHz frequency range.

11. A wireless access point unit, comprising:
an optical interface connected to an optical fiber and providing digital signals to and receiving digital signals from said optical fiber;
an RF interface connected to an antenna and to said optical interface, providing and receiving signals in a range substantially within 57-66 GHz to and from said antenna in response to signals from and to said optical interface.

12. A wireless access point, comprising:
an optical interface connected to an optical fiber and providing analog signals to and receiving analog signals from said optical fiber;
an RF interface connected to an antenna and to said optical interface, providing and receiving signals in a range substantially within 57-66 GHz to and from said antenna in response to signals from and to said optical interface.
